(19) United States
(12) Patent Application Publication
(10) Pub. No.: US 2008/0294537 A1
(43) Pub. Date: Nov. 27, 2008

(54) METHOD TO SUPPORT ADVANCE ACCOUNTING WITHIN SOFTWARE PARTITIONS

(76) Inventors: Rajeev Mishra, Bangalore (IN); Kavitha Ramalingam, Bangalore (IN); Lance Warren Russell, Rosanky, TX (US); Ajay Kumar Sami, Santhapet (IN)

Correspondence Address: DILLON & YUDELL LLP, 8911 N. CAPITAL OF TEXAS HWY.,, SUITE 2110, AUSTIN, TX, 78759, US

(21) Appl. No.: 11/751,521

(22) Filed: May 21, 2007

(51) Int. Cl. G06Q 10/00; G06F 17/40

(52) U.S. Cl. 705/30

(57) ABSTRACT

A data processing system includes: a plurality of resources including a processor, a memory, and an operating system; a mechanism for generating one or more software partitions in addition to an administrative partition; and a global accounting engine which enables monitoring and recording of resource usage at both a global-level and a partition-level. Partition-level accounting data is returned for selected resources being utilized within a software partition. The data processing system also includes a first software partition, which utilizes one or more of the first plurality of resources and which includes a first partition-level accounting engine. The partition-level accounting engine provides monitoring and recording of resource usage within the first software partition and stores first partition usage data within a first partition accounting buffer.

### BACKGROUND

1. Technical Field

The present invention generally relates to computer systems and in particular to operations within software partitioned computer systems.

2. Description of the Related Art

Computer systems are designed with a plurality of hardware and software resources that are utilized to complete processes executing on the computer system. Administrators and/or user of computer systems occasionally desire to track the usage of certain resources within the computer system environment. Conventional computer systems provide a single operating system view of the system, and the computer system includes a global accounting engine that may be utilized to track system resource usage within the single view of the computer system.

Within an UNIX system, the global system environment has an all encompassing view of processes, IPC, file systems, devices, and system level objects. This global system environment can be thought of as the traditional AIX (UNIX) login environment. With accounting within a UNIX system, an administrator provides a list of resources, whose utilization are desired to be tracked either on a per user level or a per process level. In large organizations, for example, with limited or shared resources, the individual units that make up the corporation may share certain computing resources and are responsible for covering the pro-rata costs associated with their usage.

One advanced accounting methodology available within UNIX systems provides global usage-based information for a wide variety of system resources. The administrator is able to set the accounting engine to collect accounting data on resources such as disks, network interfaces, virtual devices, file systems, processors, and memory at preset intervals. Interval accounting provides the ability to view the collected data over time intervals defined by the system administrator in order to develop chronological views of such usage. Additionally, process accounting enables tracking of the usage of specific processes. In some instances, accounting data is collected during process exit or when ever a resource is accessed. With the conventional implementations of accounting, a single global view is provided of accounting data, which is collected for the entire system.

FIG. 1 illustrates a prior art application of accounting as applied on the global system level. As shown, accounting engine 100 includes two timers that are set by a system administrator to trigger a periodic capture of system usage information from a plurality of resources 152, 154, 156 and processes 158 within the operating system environment 150. Usage information from the plurality of resources 152-156 are captured by system handlers 1-3 112-116, which receive periodic triggers from system interval timer 105. Likewise, usage information from the processes 158 is captured by process handler 118, which receives periodic triggers from process interval timer 105. All retrieved/captured resource information data are forwarded to an accounting buffer 130 and ultimately stored within disk 140. Administrative inputs 115 are received to provide setup information (e.g., timer periods) and queries, etc. Also, accounting data 135 may then be forwarded from disk 140 and may be utilized in other accounting or billing processes.

One recent advancement in computer systems is the introduction of software partitions, by which multiple instances of an operating system is spawned on a single computing system such that multiple applications may be provided using the same shared operating system and system resources. A software partition is a virtual instance of an operating system, i.e. a virtual system image, which runs using the same operating system kernel running in the host system, and which provides safe yet efficient sharing of computing system resources.

Software partitions provide an environment that is substantially similar to a standalone UNIX system. This software partition type runs most of the system services that would be found in a standalone system and the software partition does not share writeable file systems with any other software partition or with the global system.

Within the single host computing system, there may be multiple software partitions that share the operating system kernel, libraries, and the like, of the host system. Typically, with such software partitions, processes within one software partition may not affect other processes or resources outside of the software partition. In this way, each software partition is isolated from every other software partition. However, as provided above, the software partitions may share operating system resources and other system resources.

While software partitioning represents an advancement in computer systems, the above described advanced accounting functions are not supported within the conventional implementations of software partitioning. Thus, no accounting for resource usage may be completed/implemented at the software partition level.

When a computer system is divided into software partitions, the administrators within any of the software partitions are currently not able to provide accounting for resource usage, as that function is provided only at the administrative level for the global administrator (the administrator of the entire computer system). Also, the current implementations of resource accounting at the global system level do not provide partition-level resource usage data by which the usage of specific resources at the software partition may be determined.

### SUMMARY OF THE INVENTION

A data processing system, which has: a plurality of resources including a processor, a memory, and an operating system; a mechanism for generating one or more software partitions in addition to an administrative partition; and a global accounting engine which enables monitoring and recording of resource usage at both a global-level and a partition-level. Partition-level accounting data is returned for selected resources being utilized within a software partition. The data processing system also includes a first software partition, which utilizes one or more of the first plurality of resources and which includes a first partition-level accounting engine. The partition-level accounting engine provides monitoring and recording of resource usage within the first software partition and stores first partition usage data within a first partition accounting buffer.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a prior art of a global accounting system;

FIG. 2 is a block diagram of an example data processing system within which aspects of the illustrative embodiments may be implemented;

FIG. 3 is a block diagram illustrating the primary operational components of an exemplary data processing system partitioned into multiple software partitions in accordance with one illustrative embodiment;

FIG. 4 is an example computing system environment in which a partition-level accounting engines are provided within a global system to support partition-level accounting, in accordance with an illustrative embodiment;

FIG. 5 is a block diagram illustrating the primary operational components of the global and partition-level accounting systems of a computer system with software partitions that accounts for both global system usage and partition-level usage of resources, according to one illustrative embodiment; and

FIG. 6 is a flowchart of the processes involved in performing global system accounting in a computer system that includes software partitions, in accordance with one illustrative embodiment.

### DETAILED DESCRIPTION OF AN ILLUSTRATIVE EMBODIMENT

The described embodiments provides a data processing system, which has: a plurality of resources including a processor, a memory, and an operating system; a mechanism for generating one or more software partitions in addition to an administrative partition; and a global accounting engine which enables monitoring and recording of resource usage at both a global-level and a partition-level. Partition-level accounting data is returned for selected resources being utilized within a software partition. The data processing system also includes a first software partition, which utilizes one or more of the first plurality of resources and which includes a first partition-level accounting engine. The partition-level accounting engine provides monitoring and recording of resource usage within the first software partition and stores first partition usage data within a first partition accounting buffer. Other embodiments provide a method and computer program product for completing the processing of the global accounting engine and the partition accounting engine.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

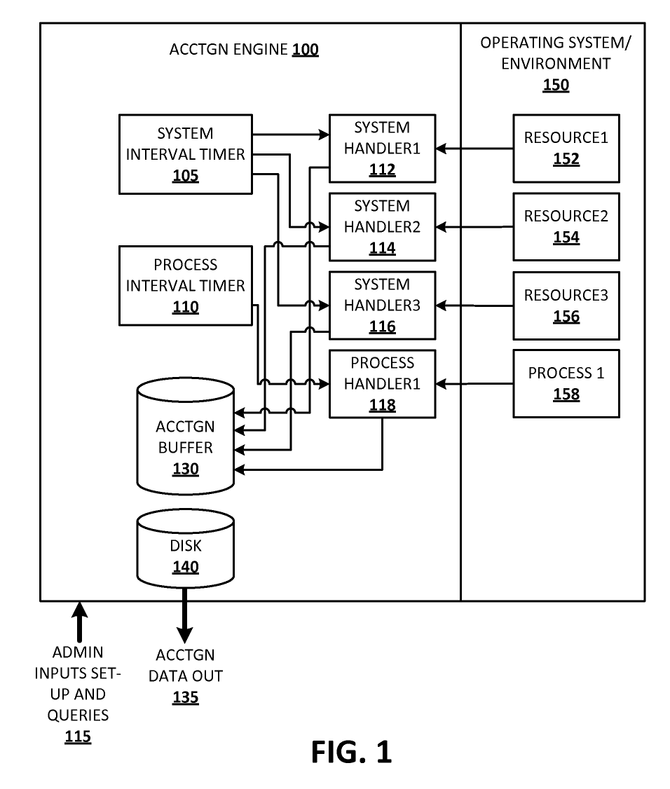

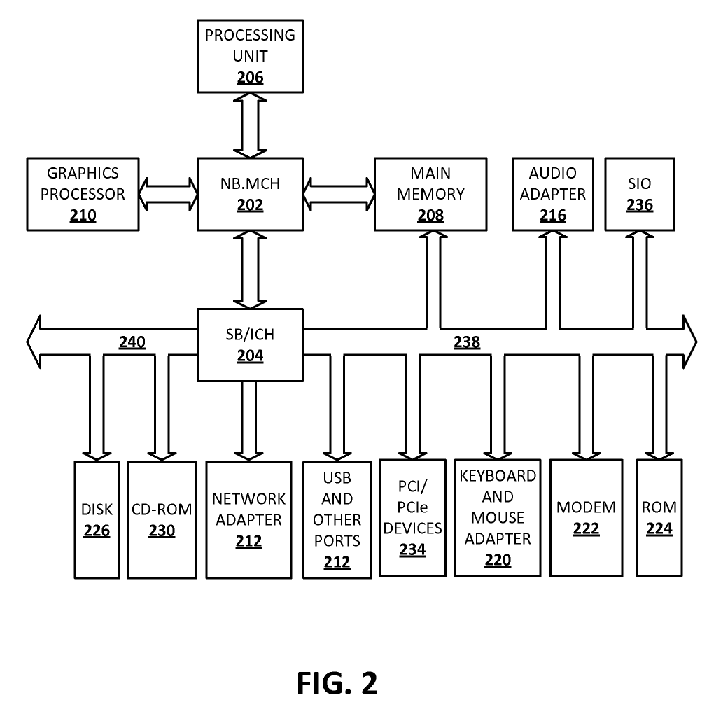

Within the descriptions of the figures, similar elements are provided similar names and reference numerals as those of the previous figure(s). Where a later figure utilizes the element in a different context or with different functionality, the element is provided a different leading numeral representative of the figure number (e.g, 1xx for FIGS. 1 and 2xx for FIG. 2). The specific numerals assigned to the elements are provided solely to aid in the description and not meant to imply any limitations (structural or functional) on the invention.

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that terms is utilized.

With reference now to the figures and in particular with reference to FIG. 2, exemplary diagrams of data processing environments are provided in which embodiments of the present invention may be implemented. It should be appreciated that FIG. 2 is only exemplary and is not intended to assert or imply any limitation with regard to the environments in which aspects or embodiments of the present invention may be implemented. Many modifications to the depicted environments may be made without departing from the spirit and scope of the present invention.

With reference now to FIG. 2, a block diagram of an exemplary data processing system is shown in which aspects of the illustrative embodiments may be implemented. Data processing system 200 is an example of a computer, such as server or client computers, in which computer usable code or instructions implement processes, according to illustrative embodiments.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

Data processing system 200 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

A bus system, such as bus 238 or bus 240 as shown in FIG. 2, may comprise one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIG. 2 may vary depending on the implementation. Other internal hardware or peripheral devices may be used in addition to or in place of the hardware depicted in FIG. 2. Also, the processes of the illustrative embodiments may be applied to a multiprocessor data processing system, rather than the single processor system illustrated, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

With particular importance to the illustrative embodiments described herein, data processing system 200 is preferably a software partitioned data processing system in which the operating system running on data processing system 200 and virtual and real device resources of the data processing system 200 are shared by a plurality of software partitions which may each be running their own independent set of one or more applications. For example, the data processing system 200 may have a plurality of software partitions that each run independent Internet web sites, instances of a search engine, or the like. Importantly, the software partitions of the data processing system 200 share the operating system via virtual instances of the operating system and share the resources (hardware and software) of the data processing system 200, but are independent and isolated from one another through software mechanisms in accordance with the illustrative embodiments described herein.

Those of ordinary skill in the art will appreciate that the hardware depicted in FIG. 2 is a basic illustration of a generalized computer system, and thus the hardware utilized in actual implementation may vary. Thus, the depicted example is not meant to imply architectural limitations with respect to the present invention. The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

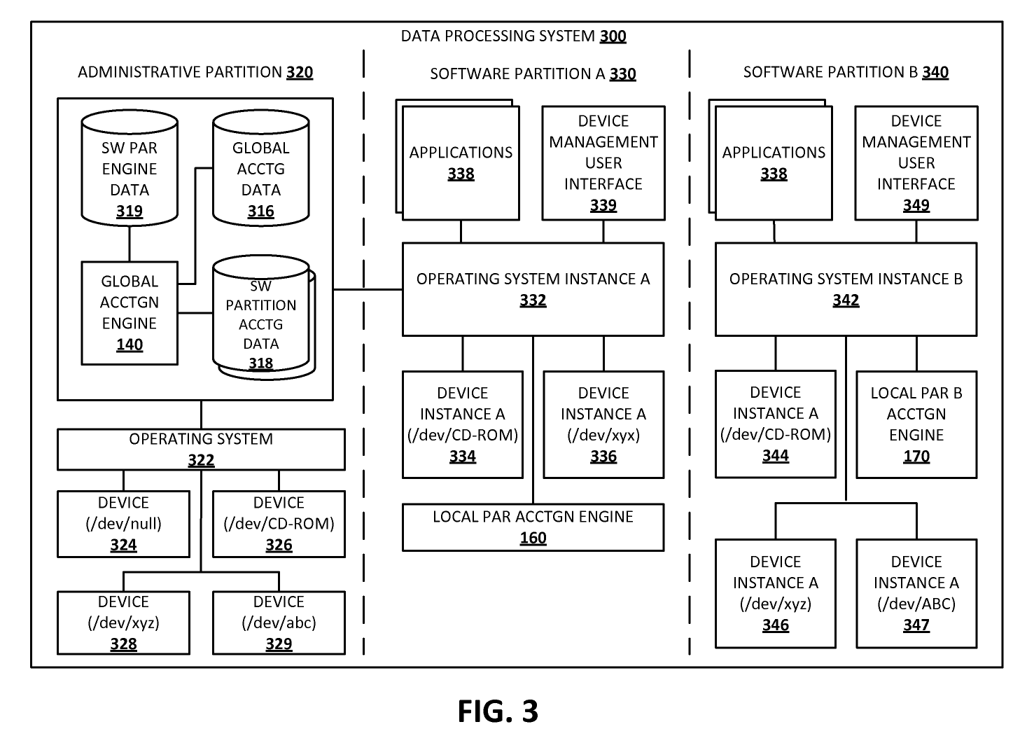

FIG. 3 is an exemplary block diagram illustrating the primary operational components of data processing system 300 divided into software partitions, in accordance with one illustrative embodiment. As shown in FIG. 3, data processing system 300 includes administrative partition 320 and two software partitions, partition A 330 and partition B 350. Administrative partition 320 comprises software partition management functionality, which includes software partition (management) engine (and data) 319, global accounting engine 314, with associated global accounting buffer 316 and partition accounting buffer 318. The software partition engine 310 is responsible for the generation and management of software partitions within the data processing system 300. Also provided in administrative partition 320 are operating system 322 and a plurality of virtual devices 324-329 which may be associated with hardware or software devices, constructs, or the like.

In one embodiment, software partition engine 310 generates software partitions 330 and 340 in response to a user or system administrator request to generate a new software partition. Such a request may be provided to the software partition management engine 310 via a user interface (not shown), for example. The software partition engine 310, in response to a request to generate a software partition, generates a virtual instance 332, 342 of the operating system 322 for the software partition 330, 340 as well as performs other operations generally known in the art for generating a software partition. These other operations may include, for example, creating filesystems, populating filesystems by performing root-part installation, establishing network configurations, establishing resource controls, and creating a restricted environment in the operating system kernel. When the software partitions are being created, the partition engine maintains a special global partition (administrative partition 320) from which the other partitions are visible.

In one embodiment, the software partition engine 310 includes a global accounting engine 314 that determines which processes and resources are being utilized at the global system level by processes running on the various software partitions. The global accounting engine 314 contains logic which triggers a plurality of handlers to detect and return various operational parameters of system resources being utilized globally and/or within the various software partitions, such as software partitions 330, 340. Additionally, the global administrator is provided enhanced privileges to account for resource usage by all processes throughout the computer system, both global-level processes as well as all or selected portions of the software partition level processes.

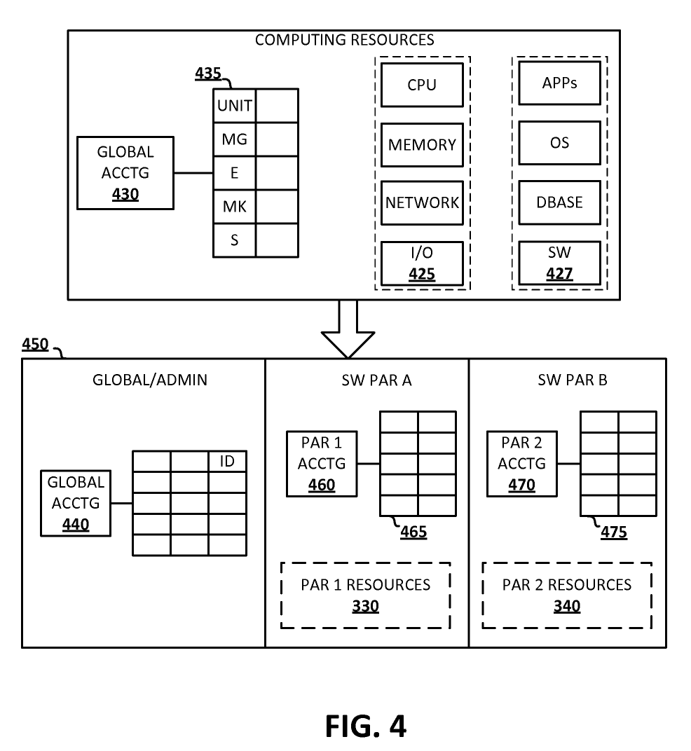

Global accounting engine 314 comprises firmware, code and/or logic, which executes on processor 205 to provide the global-level and software partition-level accounting of system resources, as described herein. Global accounting engine 314 may be provided as a part of the OS, the partition management engine, or as a stand alone addition to existing OS code and functions, for example. According to the illustrative embodiment, the global accounting module 314 enables the computer system 200 (or global administrator) to complete different-levels of resource usage accounting, which are described below and illustrated by FIGS. 4-6.

Software partitions 330, 340 also include virtual and/or real device instances 334-336 and 344-347, which represent resources that are utilized within the respective software partitions. Additionally, each software partition also includes a local partition-level accounting engine 360, 370, by which the software partition's administrator may initiate resource usage accounting within the respective software partition 330, 340. Each engine 360, 370 has an associated partition-level buffer 365, 375 within which the partition-level accounting data is stored.

The embodiments herein provide advance global-level accounting, where globally (administrative level) initiated advance accounting writes data on to the global accounting file. With the computer system operating in a system configuration that includes software partitions, the advance accounting subsystem is further modified to support partition-level accounting. That is, in one embodiment, the advance accounting system is modified to provide advance accounting data (partition-level) for software partitions in addition to the global accounting data (administrative-level) for the general system.

Providing partition-level accounting functionality enables the delegation of many system administration tasks to the partition administrator, and enables the partition administrator to conduct advanced accounting for the partition. According to the described embodiment, providing advance accounting support for partitions requires the following new modes/states of advance accounting:
a. Global initiated accounting of the partition(s): This mode collects the global requested accounting data for a partition and allows the administrator to turn on accounting in a specific manner for a specific partition. For example, the global administrator may want to find out how much resource is being used by the partition. This mode will require new advance accounting record and this record will contain the partition's identifier (ID) or name; and
b. Partition Accounting: The software partition initiates accounting for itself, perhaps triggered by the partition's administrator. No new accounting record type is required. The system will generate accounting record for the partition and the record will be available to the partition. For example CPU usage accounting record will contain the CPU utilization for that partition.

Within partition accounting, the partitions are able to define/select particular handlers representing resources of interest to that partition. The partitions also set up their own local interval timers. Finally, the partitions are able to make a request specific for that partition. In this way accounting is provided on a granular basis, separating out global and local accounting.

From a global level, usage of a particular resource within the software partition(s) may be determined as well as usage in the administrative partition. Thus, the global level involves tracking the total overall usage within the system, including tracking the usage at the partition level.

FIG. 4 illustrates a transition from a general accounting system to one that accounts for software partitions by enabling partition-level advanced accounting. FIG. 4 provides different views of the accounting environment for tracking use of system resources from a non-partitioned perspective and a software partitioned perspective. As shown within the global view 410, global accounting engine 430 generates and updates a single accounting file 435, within which global accounting engine 430 tracks the usage a specific resources. These resources include a plurality of hardware resources 425 and software resources 427 which are all available and may be utilized in the global computing system. As partitions are added to the global system, the global system takes the form of a partitioned view 450 in which there is a global or administrative “partition” 320 and software partitions, namely partition A 330 and partition B 340. In place of global accounting engine 430 and accounting file 435, administrative partition 320 now includes enhanced global accounting engine 440, which generates and maintains/updates a partition-view accounting file 445. Accounting file 445 includes identification information by which the particular partition that is utilizing a specific resource is identified. Also, each software partition includes its own partition-level accounting engine (460, 470) and associated partition-level accounting file (465, 475) by which the individual partitions are able to track usage of their respective resources.

Several modifications are provided within the global accounting engine 400 to enable the enhanced functionality described herein. First, in addition to the global system timer and process timer, each software partition is also provided a system timer and a process timer constructs. The system and process timer of each partition will then invoke system and process handlers at the required (administrator-programmed) interval to generate the accounting record(s) for the partition.

The second modification involves making the global system and global process handlers aware of the software partitions, so that the handlers are able to write the accounting data to the proper accounting buffer. In one embodiment, separate handlers are defined, global handlers and partition-level handlers. With either implementation, the partition-level accounting data requested by an accounting initiated by the global engine is forwarded to/written in the global buffer, while the partition-level initiated partition accounting data is forwarded to/written in the partition buffer. A handler that is not partition-level aware will write data only to global buffer. In one embodiment, application-specific system handlers may be injected in the global or partition-level system.

The third modification provides a partition account writer, within each partition. The partition account writer is independent of the global account writer and is also aware of the software partition. The partition account writer writes accounting buffer data to its associated partition. With the above modifications, each resource has to collect the resource utilization data at the partition level so that the resource handlers are able to dump the collected data to the relevant partition.

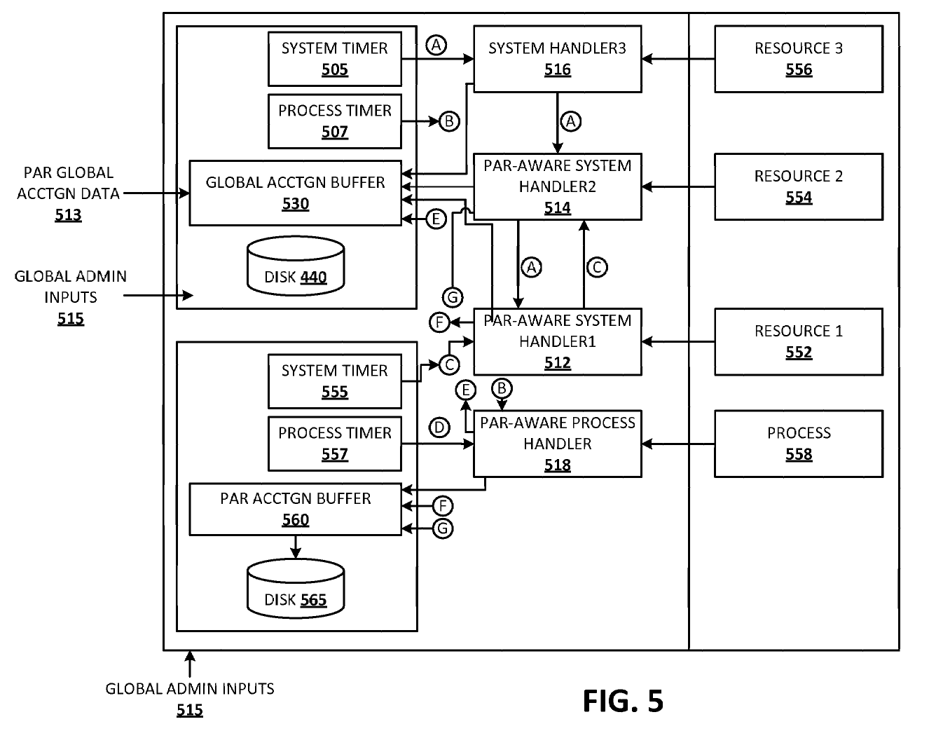

With reference now to FIG. 5, there is illustrated an example of the enhanced global (administrative-level) accounting environment that enables accounting for both the global system level as well as the partition-level based on global administrative requests/inputs. As shown, two separate accounting engines are represented within system 500, global accounting engine 501 and partition accounting engine 550, respectively representing accounting within the administrative partition and accounting within a single software partition. It is understood that any number of software partitions may be represented within the global system 500 and that each would have its own accounting engine that tracks partition-level resource usage for the partition in which the engine was running. As shown, global accounting engine 501 includes two global timers, system timer 505 and process timer 507. Each timer is set by a system administrator input 511 (or preset to a default setting) to trigger a periodic capture of system usage information from a plurality of system resources 552, 554, 556 and from executing process 558 within the system 500. System resources 552, 554, 556 are shared among the different software partitions and the global administrative environment.

Within a global system environment that includes software partitions, the handlers are designed to be partition-aware to enable accounting for resource usage occurring at the partition level. From the standpoint of global engine 501, usage information from the plurality of resources 552-556 is captured by system handlers 1-3 112-116, which receive periodic triggers from system interval timer 505. System-handlers 1 and 2 are partition-aware and retrieved usage information for resources being utilized within a partition. System handler 3 516, however tracks/monitors a resource which is not allocated to a partition or is being utilized at the administrative level, and is thus not required to be “partition-aware”. Usage information from the process 558 is captured by partition-aware process handler 518, which receives periodic triggers from process interval timer 507. The retrieved/captured resource information data are forwarded to global accounting buffer 530 and ultimately stored within disk 540. Administrative inputs 515 are received to provide setup information (e.g., set timer periods, identify resources to monitor), change system configurations, etc. Also, accounting data may be forwarded from buffer 530 or disk 540 for use within other processes.

Notably, in one embodiment, the global engine 501 receives direct inputs of partition-level global accounting data 513. This represents one embodiment, in which the partition-level data is forwarded via a call to the partition engines from the global accounting engine to provide the partition-level accounting data for usage of a particular resource within the partition. In this embodiment, use of partition-aware handlers by the global engine 501 may be optional. With both implementations, however, the accounting record which the partition account writer writes in the global file contains the name (identification ID) of the software partition so that global system administrator can correlate the accounting record with the specific software partition.

As further shown by FIG. 5, the functionality of global-level accounting is further extended to the software partition level, such that partition-level initiated accounting writes data to a local file (within partition accounting buffer 560) in the software partition. From the standpoint of partition engine 550, usage information from the plurality of resources 552-554 utilized within the software partition is captured by partition-aware system handlers 1-2 112-114, which receive periodic triggers from partition-level system interval timer 555. Usage information from the process 558 is captured by partition-aware process handler 518, which receives periodic triggers from partition-level process interval timer 557.

The retrieved/captured resource information data are forwarded to a local file of partition accounting buffer 560 and ultimately stored within disk 565. Partition-level administrative inputs 561 are received from the administrator of that partition to provide setup information (e.g., set partition timer periods, identify resources to monitor) and change partition-level configurations, etc. Also, partition-level accounting data may be forwarded from partition accounting buffer 560 or disk 565 to the partition's administrator or other process within the partition. Additionally, partition engine 550 may be configured to respond to a “call” for accounting data from global accounting engine 501 by (collecting and/or retrieving and) forwarding the partition-level accounting data from buffer 560 and/or disk 565. In one embodiment, the forwarded data is tagged with the partition ID prior to or during forwarding.

Once the accounting data is returned to the system/process handler, the accounting data is then written into the file by the global account writer or partition-level account writer. Within the flow of the administrative-level advance accounting, the (system interval and process interval) timers trigger the respective system handlers and process handler to write the system/process accounting data in the accounting buffer. Each system handler writes for a different resource. In one embodiment, the global account writer tags the partition-level accounting data with the relevant partition ID.

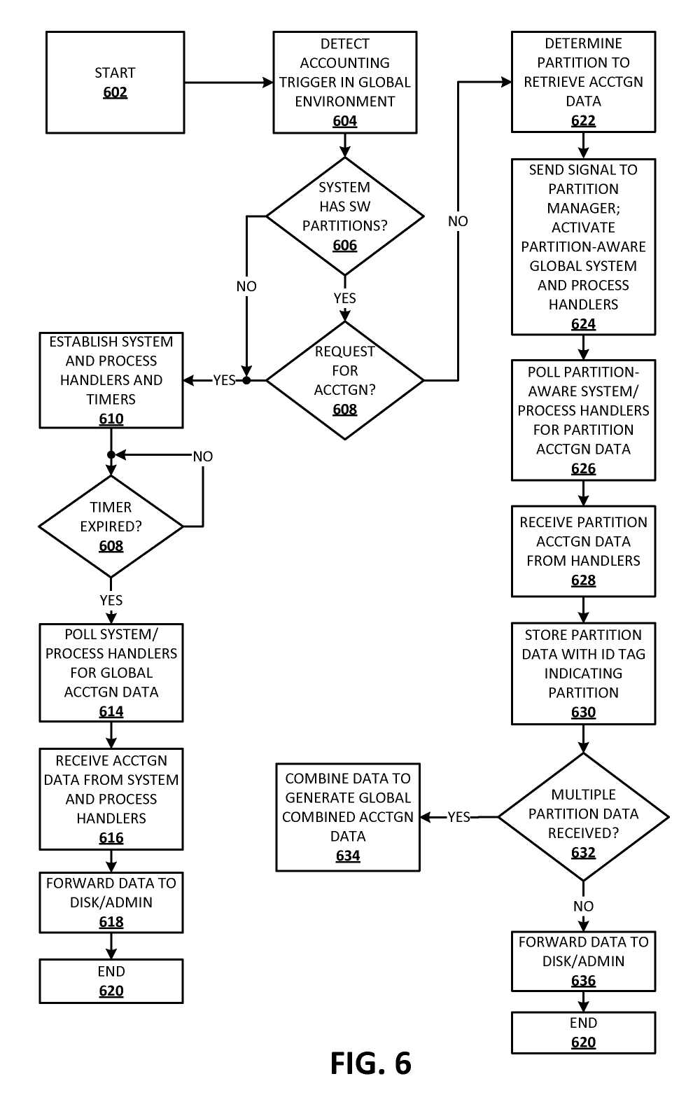

FIG. 6 is a flow chart illustrating various methods by which the above described processes are completed, according to embodiments of the invention. Although the methods illustrated in FIG. 6 may be described with reference to components shown in FIG. 2-5, it should be understood that this is merely for convenience and alternative components and/or configurations thereof can be employed when implementing the various methods. Key portions of the methods may be completed by an enhanced/modified accounting module 345 executing within computer system 200/300 (FIGS. 2/3), and the method is thus described from the perspective of modified accounting engine 345.

The process begins at block 602 and proceeds to block 604 at which the accounting engine detects a trigger within the global environment for performing an accounting. At block 606, the accounting engine determines whether the system has software partitions. If the system has software partitions, the accounting engine further determines at block 608 if the trigger detected represented a request for global (administrative-level) accounting. If the system does not have software partitions or the request is a request is for global accounting, the global accounting engine sets up the appropriate timers and process handlers to complete the global accounting, as shown at block 610. At block 612 the accounting engine determines if the timers have expired. When the timers have expired, the accounting engine triggers the process handlers to poll the system for the respective accounting data, as indicated a block 614. Then, at block 616, the accounting engine receives the global accounting data within an accounting buffer, from the system and process handlers. The accounting data are then forwarded to the permanent storage (disk) and/or to the system administrator for evaluation or further processing, as shown at block 618. The process ends at block 620.

Returning to decision block 608, assuming the request is not for global accounting but rather for accounting at a software partition level, the global accounting engine determines which partitions the administrator has requested administrative data to be retrieved from, as shown at block 622. The global accounting engine sends a signal to the partition manager and activates partition-aware global system and process handlers. Utilizing the partition-aware system and process handlers, the accounting engine polls the software partition(s) for respective partition-level accounting data, as shown a block 626. The accounting engine receives the partition accounting data from the respective partition-aware handlers (or account writers), at block 628. As shown at block 630, the partition-aware handlers store the partition-level accounting data with a respective partition ID tag, identifying within the global accounting buffer the partition from which the usage data is retrieved.

The accounting engine determines at block 632 whether partition-level accounting data is received. The accounting engine then combines the global accounting data for resources utilized by the administrative partition along with the partition-level accounting data to yield combined accounting data, as provided at block 634. This combined data includes process and system data from within the global environment as well as within any software partitions that may exist within the system. Global-level accounting data thus represents a combination of all resource usage within the overall system. This combined accounting data and/or the individual components thereof are then forwarded to the disk storage and/or analyzed by the global administrator for further processing, as shown at block 636. The process then ends at block 620.

Notably, each software partition is provided its own partition-level accounting engine and is able to perform the process steps indicated by blocks 610 through 620 within its own partition environment. The collected data, however, represents resource usage solely within that particular software partition, and that data is not visible to an administrator within another partition. In one embodiment, the individual software partition's accounting data may be retrieved by the global accounting engine in calculating the combined usage data. With this embodiment, the global accounting engine does not necessarily have partition aware handlers, but instead includes some mechanism to call the local partition accounting engine to forward its partition-level accounting data to the accounting buffer of the global administrative environment.

In the flow chart above, one or more of the methods are embodied in a computer readable medium containing computer readable code such that a series of steps are performed when the computer readable code is executed on a computing device. In some implementations, certain processes of the method are combined, performed simultaneously or in a different order, or perhaps omitted, without deviating from the spirit and scope of the invention. Thus, while the method is described and illustrated in a particular sequence, use of a specific sequence is not meant to imply any limitations on the invention. Changes may be made with regards to the sequence without departing from the spirit or scope of the present invention. Use of a particular sequence is therefore, not to be taken in a limiting sense, and the scope of the present invention is defined only by the appended claims.

As will be further appreciated, the processes in embodiments of the present invention may be implemented using any combination of software, firmware or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The methods of the invention may be practiced by combining one or more machine-readable storage devices containing the code according to the present invention with appropriate processing hardware to execute the code contained therein. An apparatus for practicing the invention could be one or more processing devices and storage systems containing or having network access to program(s) coded in accordance with the invention.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A data processing system comprising:
a plurality of resources including a processor, a memory, and an operating system;
a mechanism for generating one or more software partitions in addition to an administrative partition, said software partitions including respective instances of the operating system and instances of one or more of the plurality of resources; and
a global accounting engine which enables monitoring and recording of resource usage at both a global-level and a partition-level, wherein partition-level accounting data is returned for selected resources being utilized within a software partition.

2. The data processing system of claim 1, further comprising:
a first software partition which utilizes one or more of the first plurality of resources and which includes a first partition-level accounting engine;
wherein the first partition-level accounting engine provides monitoring and recording of resource usage within the first software partition and stores first partition usage data within a first partition accounting buffer.

3. The data processing system of claim 2, wherein further:
the first partition-level accounting engine provides monitoring and recording of process usage within the first software partition and stores first partition process usage data within the first partition accounting buffer.

4. The data processing system of claim 2, wherein further:
the first partition-level accounting engine includes a first partition-level system interval timer and a first partition-level process interval timer, which timers are preset with a periodic interval at which usage data of resources and processes within the first partition being monitored are respectively retrieved.

5. The data processing system of claim 2, further comprising:
one or more system handlers, which detect a current usage of a particular resource to which the one or more system handlers are respectively associated; and
one or more process handlers, which detect a current usage of a particular process to which the one or more process handlers are respectively associated.

6. The data processing system of claim 5, wherein:
the one or more system handlers are partition-aware system handlers, whereby the partition-aware system handlers detect usage of a resource both within a global administrative environment and a partition-level environment; and
the one or more process handlers are partition-aware process handlers, whereby the partition-aware process handlers detect usage of a process both within a global administrative environment and a partition-level environment.

7. The data processing system of claim 7, wherein the partition-aware system handler and the partition-aware process handlers return resource usage data to the global accounting buffer tagged with a particular partition ID representing the software partition within which the specific resource is being utilized, wherein resource usage data that is not tagged with a partition ID identifies data of resource usage within the administrative environment.

8. The data processing system of claim 1, wherein the global accounting engine comprises:
a system interval timer and a process interval timer, which timers are preset with a periodic interval at which usage data of resources and processes being monitored within the entire data processing system are respectively retrieved.

9. The data processing system of claim 1, wherein the global accounting engine comprises:
a first input for receiving administrative inputs for configuring and activating the global accounting engine; and
a second input for receiving partition-level global accounting data detected within one or more of the software partitions.

10. The data processing system of claim of 1, wherein the partition level global accounting data includes a partition ID appended to each data identifying the software partition from which the usage data was detected.

11. In a data processing system having a plurality of resources including a processor, a memory, and an operating system and one or more software partitions in addition to an administrative partition, a method for providing resource usage accounting, said method comprising:
responsive to activation of a global accounting engine for tracking usage of one or more resources and one or more processes within the data processing system,
retrieving administrative-level resource usage data from resources being utilized within the administrative partition;
requesting partition-level resource usage data for resource usage within the one or more software partitions; and
storing the administrative-level resource usage data along with the partition-level resource usage data within a global accounting buffer.

12. The method of claim 11, further comprising:
identifying affiliated partition-aware system handlers and partition-aware process handlers to complete monitoring and detecting of resource usage at both the administrative-level and partition-level, wherein partition-level accounting data is returned for selected resources being utilized within a software partition.

13. The method of claim 11, further comprising:
tagging the partition-level usage data with a partition ID identifying a specific partition in which the resource is being utilized to generate the partition-level resource data;
wherein the partition-aware system handler and the partition-aware process handlers return resource usage data to the global accounting buffer tagged with a particular partition ID representing the software partition within which the specific resource is being utilized, wherein resource usage data that is not tagged with a partition ID identifies data of resource usage within the administrative environment.

14. The method of claim 11, further comprising:
combining select ones or the administrative-level resource usage data and the partition-level usage data to provide combined usage data for a particular resource utilized in both the administrative-level and the partition-level.

15. The method of claim 11, further comprising:
detecting, within a first partition, an activation of a partition-level accounting engine;
establishing a partition-level system timer and a partition-level process timer, which timers are preset with a periodic interval at which usage data of resources and processes being utilized within the software partition being monitored are respectively retrieved; and
identifying affiliated partition-aware system handlers and partition-aware process handlers to complete monitoring and detecting of resource usage at the partition-level, wherein partition-level accounting data is returned to a partition-level accounting buffer for selected resources being utilized within a software partition.

16. The method of claim 11, further comprising:
receiving, at the administrative accounting engine administrative, inputs for configuring and activating the global accounting engine; and
receiving a second input of partition-level global accounting data detected within one or more of the software partitions and tagged with respective partition-IDs.

17. A computer program product for use within a data processing system having a plurality of resources including a processor, a memory, and an operating system and one or more software partitions in addition to an administrative partition, the computer program product comprising program code that when executed on the processor provides resource usage accounting functionality, said program code comprising code for:
responsive to activation of a global accounting engine for tracking usage of one or more resources and one or more processes within the data processing system,
retrieving administrative-level resource usage data from resources being utilized within the administrative partition;
requesting partition-level resource usage data for resource usage within the one or more software partitions;
identifying affiliated partition-aware system handlers and partition-aware process handlers to complete monitoring and detecting of resource usage at both the administrative-level and partition-level, wherein partition-level accounting data is returned for selected resources being utilized within a software partition;
tagging the partition-level usage data with a partition ID identifying a specific partition in which the resource is being utilized to generate the partition-level resource data;
wherein the partition-aware system handler and the partition-aware process handlers return resource usage data to the global accounting buffer tagged with a particular partition ID representing the software partition within which the specific resource is being utilized, wherein resource usage data that is not tagged with a partition ID identifies data of resource usage within the administrative environment; and
storing the administrative-level resource usage data along with the partition-level resource usage data within a global accounting buffer.

18. The computer program product of claim 17, further comprising:
combining select ones or the administrative-level resource usage data and the partition-level usage data to provide combined usage data for a particular resource utilized in both the administrative-level and the partition-level.

19. The computer program product of claim 17, further comprising program code for:
detecting, within a first partition, an activation of a partition-level accounting engine;
establishing a partition-level system timer and a partition-level process timer, which timers are preset with a periodic interval at which usage data of resources and processes being utilized within the software partition being monitored are respectively retrieved; and
identifying affiliated partition-aware system handlers and partition-aware process handlers to complete monitoring and detecting of resource usage at the partition-level, wherein partition-level accounting data is returned to a partition-level accounting buffer for selected resources being utilized within a software partition.

20. The computer program product of claim 17, further comprising program code for:
receiving at the administrative accounting engine administrative inputs for configuring and activating the global accounting engine; and
receiving a second input of partition-level global accounting data detected within one or more of the software partitions and tagged with respective partition-IDs.
